(19) United States
(12) Patent Application Publication
(10) Pub. No.: US 2020/0034807 A1
(43) Pub. Date: Jan. 30, 2020

(54) METHOD AND SYSTEM FOR SECURING TRANSACTIONS IN A POINT OF SALE

(71) Applicant: Yaron HERSHCOVICH, Herzliya (IL)

(72) Inventors: Yehuda SHAMAI, Tel Aviv (IL); Yaron HERSHCOVICH, Herzliya (IL); Ori SHMERLING, Tel Aviv (IL)

(73) Assignee: Yaron HERSHCOVICH, Herzliya (IL)

(21) Appl. No.: 16/337,422

(22) PCT Filed: Sep. 28, 2017
(86) PCT No.: PCT/IL2017/051098

§ 371 Date: Mar. 28, 2019

Related U.S. Application Data
(60) Provisional application No. 62/401,249, filed on Sep. 29, 2016.

(51) Int. Cl. G06Q 20/20; G06Q 20/32; G06Q 20/40; H04L 29/06; G06Q 20/38

(52) U.S. Cl. CPC G06Q 20/20; G06Q 20/325; G06Q 20/38215; G06Q 20/322; H04L 63/0861; G06Q 20/40145

(57) ABSTRACT

A system for payment in a point of sale is disclosed. The system may include one or more payment unit and one or more remote servers. Each payment unit may include one or more biometric sensors; a communication unit including a first cannel for communicating with a cash register and a second channel for communicating with the one or more remote servers; and a local processor configured to: receive biometric data of a person from the one or more biometric sensors; receive a request for payment from the cash register, via the first channel; and encrypt and send the information to at least one remote server for authentication and payment.

### BACKGROUND OF THE INVENTION

The process of paying for goods or services in a point of sale had not changed significantly in recent years. Nowadays, in order to pay for goods or services a customer is interested in, he or she would have two payment options, either pay with cash or pay with a payment card (i.e., credit card, debit card or prepaid card). A credit card payment will require the customer to either hand the card to a merchant or pass it himself in a card reader being in communication (or included) in the cash register. From this point on, a highly secured communication is taking placed between the card reader and a payment processor (or a third-party processor). A payment processor may be defined as a processor that handles the details of processing credit cards or other accounts related to a customer. The payment processor may further handle transactions between merchants, banks, and merchant account providers any component along the way must obey the very strict security standards of the credit companies, also known in the art as Payment Card Industry Data Security Standard (PCI DSS).

The major weakness of this payment method lays in the very first step “the customer must hold a physical card”. For example, the customer's credit card may be a stolen card used by unauthorized customer. Currently the only way the merchant can verify that the customer holding the card is the rightful owner of the card, is by asking the customer to enter a code that should have been known only to the customer or ask for an ID card. This method has several major fallbacks, for example,: 1) many people save or write their codes on notes in their wallets or smartphones, so when someone's bag or wallet is stolen, the thief can combine the code, the ID card and the credit card; 2) many people (e.g., elderly people) have difficulty remembering such codes, and 3) multi-card holders need to remember a plurality of codes and to further remember which code is associated with which credit card. Another currently use “authentication” method is to ask the customer to sign the payment payload and then if later a dispute occurs between the customer and the merchant the signature given can be compared to the one stored in the credit payment provider's database.

Another major weakness lays in the physical structure of the credit card. The information recorded on the magnetic strip and/or the chip included in the card is not encrypted and can easily be copied.

None of the above mentioned methods are immune to fraud and theft. The only way to overcome these deficiencies is to include an additional (or alternative) security element that cannot be stolen, for example, a biometric element. Biometric data received from a biometric sensor, such as, a camera, a video camera, a fingerprint detector and the like, can be used to authenticate the identity of the customer. In a case that the identified customer was previously associated with a credit card, this association may further be used as the payment method as will be broadly discussed below.

### SUMMARY OF THE INVENTION

Some aspects of the invention may be related to a system for payment in a point of sale. The system may include one or more payment units and one or more remote servers. In some embodiments, each payment unit may include one or more biometric sensors; a communication unit including a first cannel for communicating with a cash register and a second channel for communicating with the one or more remote servers; and a local processor configured to: receive biometric data of a person from the one or more biometric sensors; receive a request for payment from the cash register, via the first channel; encrypt the received biometric data and the received request for payment to form a first encrypted massage; send the first encrypted massage to the one or more remote servers, via the second channel; decrypt a second encrypted massage received from the remote server, via the second channel, including a payment confirmation from a payment processor; and send the payment confirmation to the cash register, via the first channel. In some embodiments, at least one remote server from the one or more remote servers may be configured to: decrypt the first encrypted message; compare the biometric data to stored identified biometric data; determine an identity score for the biometric data based on the comparison; send the request for payment and payment account details associated with the biometric data to the payment processor if the determined identity score is above a threshold value; receive the payment confirmation from the payment processor; encrypt the payment confirmation code to form the second encrypted message; and send the second encrypted message to the payment unit.

In some embodiments, the biometric data may include data received from two or more types of biometric sensors. In some embodiments, the at least one remote server may be further configured to: receive an additional data related to the person; and determine the identity score for the biometric data also based on the additional data. In some embodiments, each of the one or more remote servers is further configured to: verify that the first and second channels are authorized communication channels prior to receiving the first incepted message.

In some embodiments, the first channel may be configured to send and receive the first and second encrypted messages via an encrypted communication protocol. In some embodiments, the system may further include: an intercepting unit configured to: send the payments unit the request for payment from the cash register; and send the payment confirmation from the payment unit to the cash register.

In some embodiments, the local controller may further be configured to: receive, via an input device, payment account details associated with the person and the first encrypted massage may further include the payment account details. In some embodiments, the remote server may further be configured to: associate the biometric data of the person with the payment account details. In some embodiments, the remote server may further be configured to: send to a mobile device associated with the person a message; receive from the mobile device a response to the sent message; and verify the identity of the person based on received response. In some embodiments, each of the one or more remote servers may further be configured to: receive a plurality of first encrypted messages, over a period of time, each of the first encrypted message may include biometric data of the same person; compare the received biometric data to stored identified biometric data; determine identity scores for the received biometric data based on the comparison; and update the threshold value based on the determined identity scores.

Some additional aspects of the present invention may be directed to a method of payment in a point of sale. The method may include receiving biometric data of a person from one or more biometric sensors; receiving a request for payment from a cash register; encrypting the received biometric data and the received request for payment to form a first encrypted massage; sending the first encrypted massage to a remote server; decrypting the first encrypted message, by the remote server; comparing the biometric data to stored identified biometric data; determining an identity score for the biometric data based on the comparison; sending the request for payment and payment account details associated with the biometric data to a payment processor if the determined identity score is above a threshold value; receiving a payment confirmation from the payment processor; encrypting the payment confirmation to form a second encrypted message; and sending the second encrypted message to a payment unit; decrypting the second encrypted massages received from the remote server including the payment confirmation from the payment processor; and sending the payment confirmation to the cash register.

In some embodiments, the biometric data may include data received from two or more types of biometric sensors. In some embodiments, the method may further include receiving an additional data related to the person and determining the identity score for the biometric data also based on the additional data. In some embodiments, the method may further include receiving, via an input device, payment account details associated with the person and the first encrypted massage further includes the payment account details; and associating the biometric data of the person with the payment account details.

In some embodiments, the method may further include: sending to a mobile device associated with the person a message; receiving from the mobile device a response to the sent message; and verifying the identity of the person based on received response. In some embodiments, the method may further include: receiving a plurality of first encrypted messages, over a period of time, each of the first encrypted message may include biometric data of the same person; comparing the received biometric data to stored identified biometric data; determining identity scores for the received biometric data based on the comparison; and updating the threshold value based on the determined identity scores.

Some additional aspects of the present invention may be directed to a method of associating biometric data with a person. The method may include receiving biometric data of a person from one or more biometric sensors; receiving payment account details associated with the person; encrypting the received biometric data and the received payment account details to form a first encrypted massage; sending the first encrypted massage to one or more remote servers; decrypting the first encrypted message, by the one or more remote servers; and associating the biometric data of the person with the payment account details.

In some embodiments, the method may further include: receiving a request for payment from a cash register; encrypting the request for payment to be included in the first encrypted massage; determining an identity score for the biometric data; sending the request for payment and the payment account details associated with the biometric data to a payment processor if the determined identity score is above a threshold value; receiving a payment confirmation from the payment processor; encrypting the payment confirmation to form the second encrypted message; sending the second encrypted message to a payment unit; decrypting the second encrypted massages received from the remote server including the payment confirmation from the payment processor; and sending the payment confirmation to the cash register.

In some embodiments, the biometric data may include data received from two or more types of biometric sensors. In some embodiments, the method may further include receiving an additional data related to the person; and determining the identity score for the biometric data may also be based on the additional data.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a high level block diagram of a system for payment in a point of sale according to some embodiments of the invention;

FIG. 2 is a flowchart of a method of payment in a point of sale according to some embodiments of the invention;

FIG. 3 is a flowchart of a method of payment in a point of sale according to some embodiments of the invention; and

FIG. 4 is a high level block diagram of a computing system according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

Some aspects of the invention may be directed to a system and a method for proving automatic payment service in a point of sale using biometric data. A customer approaching a point of sale (e.g., a cash register) with goods to be purchased, may use the service to pay for the goods only by being identified using his/her biometric parameters. A payment unit according to some embodiments of the invention may be in communication with a cash register (or with an automatic self-checkout machine) for receiving a request for payment and may further include one or more biometric sensors for gathering biometric data of a person. The customer may be asked by the merchant (or by an automatic self-checkout machines) to allow the one or more biometric sensors to take a picture of the customer and/or place his/her hand on a fingerprint reader, or the like.

In some embodiments, the payment unit may than send the biometric data and the request for payment to a service center that may include one or more remote servers. The biometric data may be used to identify the customer and that identification may be used for associating the customer to previously stored payment account associated with the user, for example, credit card details, gift cards details, food cards details, bank accounts details and the like.

As disclosed herein, embodiments related to credit card details are also applicable with other payment accounts related to a specific user, such as gift cards, food cards, bank accounts, crypto currencies accounts, and the like. The credit card details and the request for payment may then be sent to a payment processor for completing the payment and receiving a payment payload. The payment payload may be sent from the service center to the payment unit and then to the cash register to complete the purchase. From the customer's point of view it is “pay by giving a picture (or any other biometric data) process”. The payment method according to embodiments of the invention may be simple, customer friendly and much more secured than the currently existing payment methods, since nobody, except the credit card holder, may have the credit card details or any physical contact with the credit card.

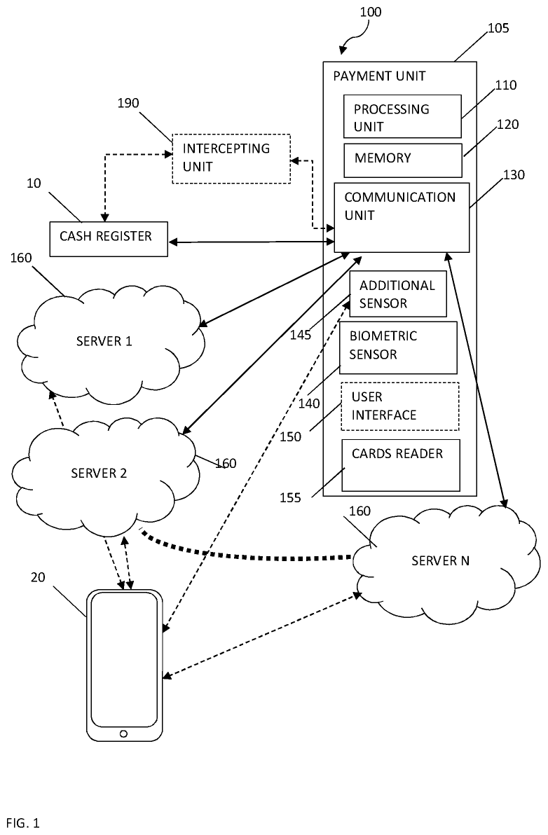

Reference is made to FIG. 1 which is a high level block diagram of a system for securing transaction and/or payment in a point of sale according to some embodiments of the invention. A system 100 may include one or more payment units 105 and a plurality of remote servers 160. The plurality of servers may be included in a service center for supplying payment collecting services. Each of one of remote servers 160 may be configured to send requests for payment and payment account details (e.g., credit card details) to payment processors. Each one of servers 160 may be authorized to send the requests for payment and the credit card details to at least one payment processor under the PCI DSS.

Payment unit 105 may include: a local processing unit 110, a communication unit 130 and one or more biometric sensors 140. In some embodiments, payment unit 105 may further include an additional sensor 145 or be connected to an external device, for example, an RF antenna included, for example, in an RF based ID detector, a Bluetooth antenna and the like. In some embodiments, cash register 10 may be included in payment unit 105. Local processing unit 110 may be, for example, a central processing unit (CPU), a chip or any suitable computing or computational device (e.g., PC, mini PC, internet of things (IOT) device and the like). Local processing unit 110 may be configured to carry out methods according to embodiments of the present invention by for example executing instructions stored in a memory such as a memory 120.

In some embodiments, local processing unit 110 may further include an operating system that may include any code segment designed and/or configured to perform tasks involving coordination, scheduling, arbitration, supervising, controlling or otherwise managing operation of processing unit 110, for example, scheduling execution of programs. The operating system may be a commercial operating system. Memory 120 may be or may include, for example, a Random Access Memory (RAM), a read only memory (ROM), SSD (Solid state drive), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units.

Memory 120 may store any executable code, e.g., an application, a program, a process, task or script. The executable code may include codes for controlling a payment unit or instruction for executing methods according to embodiments of the present invention. The executable code may be executed by processing unit 110 possibly under the control of an operating system. In some embodiments, payment unit 110 may further include an additional storage unit for storing data or may use memory 120 for storing data.

Communication unit 130 may include two different communication channels. A first channel that may be configured to send and receive data from cash register 10. The first channel may include a USB port (or any other suitable port) for wired communication with cash register 10. Additionally, or alternatively, the first channel may wirelessly communicate with cash register 10, for example, via Wi-Fi, Bluetooth, Near Field Communication (NFC), or the like. In some embodiments, a USB key dongle may be connected to a USB port in cash register 10 to form the wireless communication with payment unit 105. For example, the USB key dongle may hardware and software elements for communicating with payment unit 105. In some embodiments, the first channel may communicate with cash register 10 via the internet. In some embodiments, when cash register 10 is included in payment unit 105, the first channel may be an internal channel inside payment unit 105. A second channel may be configured to communicate with one or more remote servers 160, for example, via the internet (e.g., using: GSM 2G-4G, long term evolution (LTE), Internet Protocol Suite or TCP/IP model or TCP/IP stack, OSI protocols and the like) . The second channel may include wired (e.g., LAN communication port) or wireless (e.g., Wi-Fi antenna) devices. In some embodiments, the first channel and the second channel may be the same channel configured to alternately communicate with one or more remote servers 160 and cash register 10.

In some embodiments, both the first channel and the second channel may be authorized channels. All communication may be encrypted to form an end-to-end secured communication between remote servers 160 and payment unit 105. In some embodiments, the second channel may be configured to use an encrypted communication protocol to send and receive messages to and from one or more remote servers 160.

One or more biometric sensors 140 may include any sensors that can collect biometric data (e.g., metrics related to human characteristics). For example, sensor 140 may be any camera at any resolution and any pixel density (e.g., camera, video camera, IR camera or the like) that is configured to take a picture of a person (e.g., the face (for face recognition), half body or full body) or a stream of images (e.g., a video). In another example, sensor 140 may be a fingerprint reader (e.g., a digital camera, ultrasonic sensor or the like) for capturing at least one fingerprint of a person (for finger print recognition). In yet another example, sensor 140 may include camera(s) for capturing an iris of a person, for iris recognition, using visible light and/or near IR cameras. In yet another example, sensor 140 may be or may include a microphone for recording voice samples from the customer (e.g., for performing voice recognition). In some embodiments, local processing unit 110 may be configured to processes images received from one or more sensors 140 and to extract the biometrics from the images. Additionally, or alternatively, the processing may be done by one or more servers 160.

In some embodiments, a customer approaching cash register 10 may choose to pay for goods using the secured method according to some embodiments. Such a customer may be asked to let one or more sensors 140 take his/her picture, fingerprint, iris picture, voice sample, and/or the like. The biometric data collected by sensor 140 may include a single type of biometric data (e.g., a voice sample) or a combination of two or more types of biometric data (e.g., a picture and a fingerprint). The biometric data collected by sensor 140 may be used to identify the customer (e.g., by sever 160) and associated the identified customer with payment account details (e.g., credit card details) of the person, for example, the credit card number, the expiration date, the card holder name and the amount to authorize/capture.

In some embodiments, payment unit 105 may further include a user interface 150. User interface 150 may be or may include a screen (e.g., a monitor, a display, a CRT, etc.), a pointing device and an audio device. User interface 150 may include or be associated with other input devices such as, a keyboard. The pointing device may be a mouse, a touch screen, a pad and the like. In some embodiments, user interface 150 may be included in cash register 10 and payment unit 105 may communicate (via communication unit 130) with user interface 150.

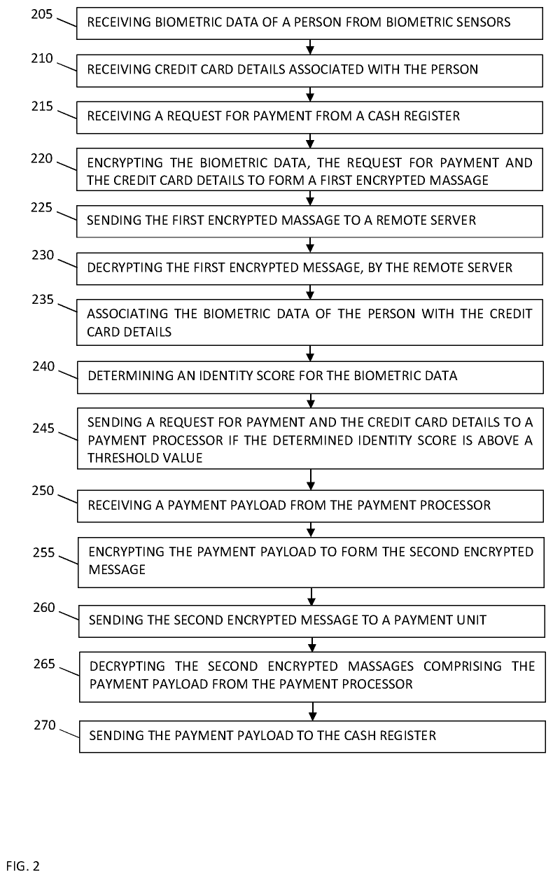

In some embodiments, payment unit 105 may include a card reader 155 for reading credit cards. Card reader 155 may be connected either wirelessly or by wire communication to processing unit 110. A customer approaching payment unit 105 may be required during a registration stage (discussed with respect to the flowchart of FIG. 2) to pass his/her credit card in order to associate the biometric data received from one or more biometric sensors 140 with the credit card details of the customer.

In some embodiments, system 100 may further include an intercepting unit 190 for connecting payment unit 105 to cash register 10. Intercepting unit 190 may be connected to payment unit 105 and/or cash register 10 via wired or wireless communication, for example, using a USB port.

In some embodiments, an additional security level may be applied in order to fully confirm the identity of the customer. Payment unit 105 may receive from additional sensor 145 or other external device additional information related to the identity of the person. For example, additional sensor 145 may identify a mobile device 20 held by the person, for example, by detecting using RF based ID detector the Media Access Control (MAC) address of mobile device 20. In some embodiments, additional sensor 145 may identify a plurality of MAC addresses of mobile devices located in proximity to payment unit 105 and processing unit 110 may be configured to associate at least one of the MAC addresses with the biometric data.

In some embodiments, another security level may be applied in order to fully confirm the identity of the customer. In some embodiments, system 100 may be configured to send and receive messages to and from a mobile device 20 associated with the paying customer. Mobile device 20 may be any mobile computing device, such as for example, a laptop, a tablet, a smartphone and the like. In some embodiments, mobile device 20 may be a designated device that is configured mainly to communicate with communication unit 130. For example, mobile device 20 may include an antenna for short range communication such as: Bluetooth communication, NFC communication and the like. In such embodiments, communication unit 130 may be configured to detect that mobile device 20 is within a certain transmission range (e.g., less than 1.5 meters, few centimeters, etc.) from payment unit 105, thus activate a communication channel between mobile device 20 and payment unit 105.

In some embodiments, the details stored in the one or more remote servers 160 may include communication details of mobile devices, such as a mobile phone number, an e-mail address, MAC addresses and the like. Each of the communication details may be associated with an identified person and payment account details (e.g., credit card details). System 100 may communicate with mobile device 20 using any known communication method such as Wi-Fi, Bluetooth, NFC and the like.

In some embodiments, once system 100 has identified the customer based on the given biometric data, the system may send a message to the customer's mobile device using the communication details stored in the system for that identified customer. The message can include: an SMS, push notification message, an e-mail, activation of an application, or the like. The message may include a request to perform an act by the user, for example, a link the user must open, a message the user must send back, a button (e.g., on the screen) the user must touch or the like. The act performed by the user may send to system 100 a response to the message sent by system. Once the response has been received, system 100 may further confirm the identity of the customer and may proceed with the payment as will be broadly discussed below.

In some embodiments, system 100 (e.g., server 160) may further receive from mobile device 20 the biometric data of the customer. For example, the customer can take his/her own picture “a selfie” and/or his/her fingerprint using the mobile device camera or fingerprint reader and send it to at least one server 160.

In some embodiments, before using the payment system of FIG. 1 a customer will be required to register into the system in order to associate his/her biometric data with his/her credit card details. The registration and enrolment process may be done in several ways. For example, in the first time a customer is approaching payment unit 105 he/she may be requested to register to the service of automatic payment by a biometric data offered according to some embodiments of the invention. The customer may approach payment unit 105 in order to purchase goods or just to register for the service. In another example, the customer may register using his/her mobile device. The customer may run an application that may ask the customer to enter a real-time “selfie” and payment account details (e.g., credit card details), for example, manually entered, scanned via OCR or any other means of reading the card. In yet another example, the registration may be conducted in a kiosk for picking up credit cards when the customer is coming to collect his/her credit card. In such a case an automatic machine may offer to the customer to give biometric data and send the credit card details and the biometric data to one or more servers 160. In yet another example, a vending machine or an ATM may offer the customer the option to register to the service. I such a case the vending machine or the ATM may be associated with one or more biometric sensors (e.g., a camera located in proximity to the ATM) and while the person is purchasing goods/drawing money a photo/video/fingerprint of the customer may be taken and associated with his/her credit card details.

Reference is now made to FIG. 2 which is a flowchart of a method of securing transaction and/or payment in a point of sale according to some embodiments of the invention. The method of FIG. 2 may be performed by system 100 of FIG. 1 and may include a method of associating biometric data with a person. The method of associating biometric data with a person may be performed by other systems.

In operation 205, embodiments may include receiving biometric data of a person from one or more biometric sensor. For example, local processing unit 110 may receive from one or more biometric sensors 140 a captured biometric data such as, a picture, a fingerprint, voice sample, an iris picture, a video recording and any combination thereof, of a person (e.g., the customer) approaching payment unit 105 with goods to be purchase. Local processing unit 110 (or later server 160) may further process the captured biometric data to extract metrics related to the customer's characteristics. For example, if the captured biometric data is a photo of the face of the customer, processing unit 110 or server 160 may perform a face recognition process by extracting landmarks, or features from the photo. A face recognition algorithm may analyze the relative position, size, and/or shape of the eyes, nose, cheekbones, and jaw.

In another example, biometric sensor 140 may capture a video recording of the person (e.g., customer) and processing unit 110 and/or server 160 may analyze typical movements of the person to form the biometric data. In yet another example, biometric sensor 140 may be a microphone configure capture voice samples of the customer and processing unit 110 and/or server 160 may perform a voice recognition analysis of the voice samples to form the biometric data. In some embodiments, the processed biometric data may include extract metrics related to the customer's characteristics received from more than one type of biometric sensor. For example, the biometric data may include data received from a camera and a microphone.

Alternatively, the one or more biometric sensors may be included in a registration unit (e.g., a kiosk for picking credit cards) placed in a bank, a post office and the like, and the customer collecting his/her credit card for the first time may be offered to register to the automatic payment service according to embodiments of the invention, by giving biometric data. In another option, the one or more biometric sensors may be included in the customer's mobile device (e.g., device 20) and the customer may send to one or more servers 160 a real time “selfie” and/or a fingerprint taken by mobile device 20. For example, a registration application running on mobile device 20 may request the customer to take and send a picture of him/her self. In some embodiments, a security code for activating mobile device 20 may use as a “second security measurement” when using mobile device 20 for registration. For example, a security code and/or a fingerprint may be required for activating the registration application prior to sending the “selfie” or finger print and the payment account details (e.g., credit card details).

In operation 210, embodiments may include receiving payment account details (e.g., credit card details) associated with the person. For example, credit card details may include: credit card number, expiration date, card holder name and amount to authorize/capture. Other account details may include, account number, owner's ID number and the like. The credit card details may be received from card reader 155 included in payment unit 105. Alternatively, the credit card details may be received from cash register 10, when a merchant or the customer passes the credit card, or other cards in a card reader included or associated with cash register 10. In another option, the credit card details may be received from a server of a credit card collecting kiosk , when the customer arrive to the kiosk to collect the credit card and gives his/her biometric data. In yet another option, the payment account details (e.g., credit card details) may be received from a mobile device associated with the customer. The customer may activate the registration application running on device 20 that may ask the customer to give biometric data and enter the payment account details (e.g., credit card details).

In operation 215, embodiments may include receiving a request for payment from a cash register (e.g., cash register 10). The request may be received when the customer would like in addition to being registered to the service, buy some goods. A merchant (or the customer at a self-checkout) may enter the prices of the goods (e.g., by reading a bar code) and cash register 10 may calculate the amount to be paid and issue a request for payment.

In some embodiments, the method may further include receiving an additional data related to the person, for example, form additional sensor 145 or directly from mobile device 20. The additional data may be related to a mobile device held by the person. The additional data may be for example, a MAC address.

In operation 320, embodiments may include encrypting the received biometric data and the received credit card details to form a first encrypted message. In some embodiments, the additional data may be included in the first encrypted message. In some embodiments, the first encrypted message may further include the request for payment. For example, the biometric data may include the one or more captured biometric data (signals) (e.g., captured image, recorded voice, recorded video and/or the like) taken by biometric sensors 140 (e.g., photo of the face and/or fingerprint) or data extracted from the captured biometric data. In some embodiments, local processing unit 110 may perform any encryption process known in the art in order to encrypt the received biometric data, the received payment account details (e.g., credit card details) and/or the request for payment and to form the first encrypted message. In some embodiments, the registration unit in the kiosk or the registration application running on the customer's mobile device may perform the encryption and form the first encrypted message.

In some embodiments, the encryption (and decryption) may include any encryption/decryption methods known in the art. For example, the encryption may be done using cyclic redundancy check (CRC) which is an error-detecting code commonly used in digital networks and storage devices to detect accidental changes to raw data. In another example, the encryption may be done using a Secure Sockets Layer (SSL) which is a standard security technology for establishing an encrypted link between a web server and a browser. In yet another example, the encryption may be done using a Hardware Security Module (HSM) which is a physical computing device that safeguards and manages digital keys for strong authentication and provides crypto-processing.

In operation 225, embodiments may include sending the first encrypted message to one or more remote servers. Local processing unit 110, the registration unit or the mobile device registration application, may send the first encrypted message to one or more remote servers 160, for example, via the internet. In some embodiments, local processing unit 110, the registration unit or the mobile device registration application, may send the first encrypted message to a service center (e.g., in a cloud) and the service center may decide to which one of the one or more remote servers 160 to progress the first encrypted message based, for example, on availability.

In operation 230, embodiments may include decrypting the first encrypted message, by the one or more remote servers. Each one of remote servers 160 that received the first encrypted message may be configured to decrypt the encryption using any known method. After decrypting the message remote server 160 may further process the received information.

In operation 235, embodiments may include associating the biometric data of the person with the payment account details (e.g., credit card details). For example, each of remote servers 160 may be configured to associate the biometric data with the name of the credit card holder (e.g., the customer), the credit card number, the expiration date, and the like. In order to further verify that the customer from which the biometric data was taken is the payment account owner (e.g., credit card holder) (or a person authorized by the credit card holder to use the credit card) a manual authentication may be performed, for example, by the merchant or the banker in which the customer may further be required to show an ID card or supply identification data, such as ID number, passport number, date of birth and the like.

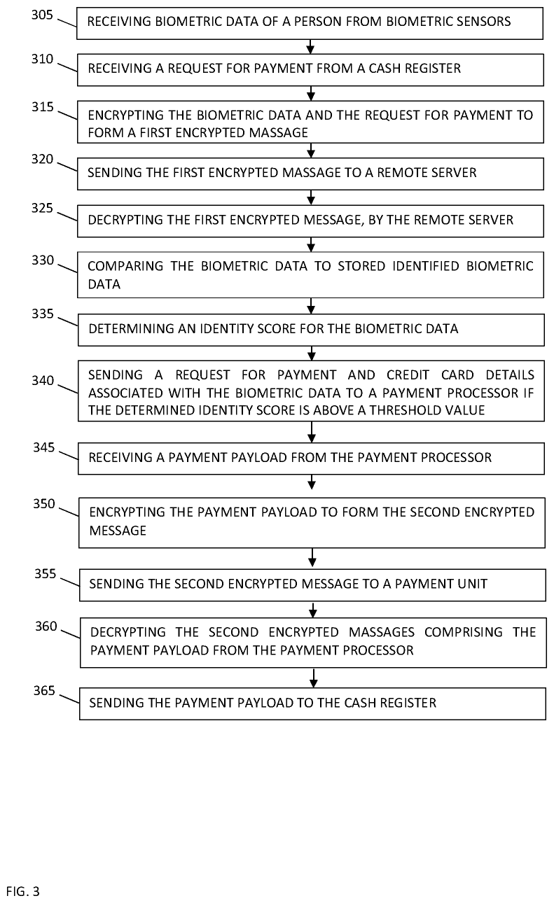

In some embodiments, after the end of operation 235, the customer may be registered to the automatic payment service. Accordingly, the next time the customer would like to pay for goods at any store that uses the automatic payment service and has at least one payment unit 105, the customer may do so just by providing a biometric data to system 100 (e.g., by letting a camera of sensor 140 take the customer's photo). This payment method will be discussed with respect to the flowchart of FIG. 3.

In some embodiments, if during the registration process the customer may further be interesting in purchasing goods, embodiments of the method of FIG. 2 may include determining an score (e.g., an initial identity score) for the biometric data (operation 240). The initial score may be determined based on data and metadata extracted from biometric data. For example, the number of images needed to be taken until a solid biometric data can be extracted, a location at which the biometric data was taken (for example, a supermarket at potential fraud committing areas (areas with high crime rates)) and like. In some embodiments, the initial identity score may further be determined based on the amount and type of biometric data. For example, a higher identity score may be given to biometric data that includes face metrics, voice metrics and fingerprint metrics in comparison to data that includes only face metrics. In some embodiments, the initial identity score may further be determined based on additional data. For example, if an additional data related to a mobile device operated by the customer is received (e.g., MAC address) and associated with the person, the biometric data may receive a higher initial score.

In operation 245, embodiments may include sending the request for payment and the payment account details (e.g., credit card details) associated with the biometric data to a payment processor

In operation 250, embodiments may include receiving a payment payload from the payment processor. The payment payload may then be encrypted by one or more remote servers 160 to form a second encrypted message, in operation 255.

In operation 260, embodiments may include sending the second encrypted message to a payment unit. One or more remote servers 160 may send processing unit 110 via communication unit 130 the encrypted payment payload. Local processing unit 110, receiving the second encrypted message may, in operation 265, decrypt the second encrypted messages received from the remote server including the payment payload from the payment processor. Local processing unit 110 may then, send the payment payload to cash register 10 (e.g., via a first channel), in operation 270.

Reference is now made to FIG. 3 which is a flow chart of a method of securing transaction and/or payment in a point of sale according to some embodiments of the invention. The method of FIG. 3 may be performed by system 100 of FIG. 1. Operation 305 may be substantially similar to operation 205 and operation 310 may be substantially similar to operation 215 of the method of FIG. 2. In operation 315, the embodiments may include encrypting the received biometric data and the received request for payment to form a first encrypted message. In some embodiments, the additional data may be included in the first encrypted message, as discussed above. The biometric data may include the captured biometric data taken by biometric sensor 140 (e.g., photo of the face, a voice sample and/or a fingerprint) or data extracted from the captured biometric data. Local processing unit 110 may perform any encryption process known in the art in order to encrypt the received biometric data, the additional data, and the request for payment and to form the first encrypted message.

Operations 320 and 325 of FIG. 3 may be substantially the same as operations 225 and 230 of FIG. 2, that were broadly discussed above. In operation 330, embodiments may include comparing the biometric data to stored identified biometric data. In some embodiments, one of remote servers 160 may compare the biometric data extracted from the photos/fingerprints/etc. received from one or more biometric sensors 140 with biometric data stored for identified persons and associated with payment account details (e.g., payment account details (e.g., credit card details). For example, remote server 160 may scan all the biometric data stored in one or more remote servers 160 to find the closest match to the received biometric data.

In operation 325, embodiments may include determining an identity score for the biometric data based on the comparison between the received biometric data and the stored biometric data. Once a potential match was found, remote server 160 may be configured to estimate how strong the matching is and to give an identity score. For example, in a face recognition processes if a match was found in 4 out of 5 facial features an identity score of 0.8 may be given to the comparison. In yet another example, if in a face recognition processes a match was found in 3 out of 5 facial features but in an additional voice recognition process a match was found in 3 out of 5 voice features, an identity score of 0.8 may be given to the comparison although lower scores was given to each recognition process separately.

In some embodiments, the identity score for the biometric data may further be determined based on the additional data. For example, the additional data received from sensor 145 may include data related to a mobile device (e.g., MAC address). Remote server 160 may be configured to compare the data with stored data related to the mobile device of the person. If a match is found, the identity score may be given a higher value (e.g., 0.9) even if the comparison of the biometric data is resulted in a lower value (e.g., 0.6). In some embodiments, the data related to a mobile device may include a plurality of MAC address received from a plurality of mobile devices present in a detection distance from sensor 145. In such case remote server 160 may be configured to detect in the plurality of MAC address the one associated with the person from which the biometric data was received.

In operation 340, embodiments may include sending the request for payment and payment account details (e.g., credit card details) associated with the biometric data to a payment processor if the determined identity score is above a threshold value. Remote server 160 may send the request for payment the payment account details (e.g., credit cards details) associated with the biometric data (e.g., in operation 235 of the method of FIG. 2) to the payment processor, if the identity score is above a predetermined threshold value (e.g., 0.7).

In some embodiments, the predetermined threshold value may change and updated in time. For example, when a customer reputedly uses the automatic payment method according to embodiment of the invention, a plurality of biometric data files (e.g., data extracted from a plurality of photos) may be received by system 100. For example, when receiving a plurality of first encrypted messages for the same customer, over a period of time, each of the first encrypted message may include biometric data of the same person. Therefore, each newly received biometric data may be compared to at least some the identified biometric data previously stored. Since for each received biometric data an identity score is determined, each new identity score may be used for updating the threshold value. For example, if during a month a customer used system 100 for 5 times for paying for goods and in the process 5 identity scores may be given to the biometric data given by the customer, 0.6, 0.5, 0.9, 0.75 and 0.85. In some embodiments, remote server 160 may be configured to update the initial given threshold value (e.g., 0.7) with the mean threshold value 0.72 of the all the 5 determined identity scores. In some embodiments, remote server 160 may be configured to select an updated threshold value based on the number of received and identified biometric data. The higher the number of received and identified biometric data the higher will be the threshold value. For example, if the initial threshold value for the first 5 uses of system 100 may be 0.7, the threshold value may rise to 0.75 for the next 15 uses and to 0.8 for the next 30 uses. The more the customer uses system 100, the higher is the confidant of the bio-metric identification process and a higher threshold value is set.

In some embodiments, in order to further verify the identity of the customer holding the credit card or the account owner, the method may include sending to a mobile device associated with the customer (e.g., the credit card holder) a message. One or more remote servers 160 may store together with the payment account details (e.g., credit card details) communication details (e.g., mobile phone numbers, email addresses or the like) of the credit card holders (or an authorized users). After associating the biometric data to the payment account details (e.g., credit card details), server 160 may send a message such as, SMS or email to the mobile device using the stored communication details. The message may include a link or a request to send a response message in response to the send message. The response may include, opening a link, sending an SMS or the like. In some embodiments, the response may include an automatic message and response received from an NFC token (chip) based on magnetic field induction. A designated NFC token may be included mobile device 20 and when mobile device is within a small distance (e.g., several centimeters) communication unit 130 may recognized the designated token of mobile device 20 and verify device 20 and/or the identity of the customer holding device 20. In some embodiments, the method may include verifying the identity of the person based on received response. For example, remote server 160 may send the request for payment to the payment processor only if the right response message was received.

In some embodiments, the need to use such an additional authentication method may be determine by server 160 according to a fraud expectancy rule that may determine if there is a high probability (e.g., higher than a threshold value) that a fraud act has been performed. For example, if the credit card was used distinguishably different than former usage of that credit card (e.g., at odds hours (e.g., in the middle of the night), for purchasing different good (e.g., alcohol instead of groceries and the like) that may indicate that the credit card has been stolen. In such a case a message may be send to the mobile device associate with the user that requires from the user to verify the purchase and further to enter a code known only to the user or additional biometric data, such as, a fingerprint.

In some embodiments, a single credit card or a single payment account may be associated with a plurality of users (e.g., customers) for example, several workers in an office that are authorized to use the office's credit card, several family members that are authorized to use the same credit card and the like. In such an embodiment, server 160 may store data related to the plurality of users (e.g., biometric data, mobile devices, pin codes and the like) and associate them with a single credit card or other payment account. Each member of the plurality of users may be required to separately register to the payment service according to embodiments of the invention, using any of the methods disclosed above.

In some embodiments, a single user may be associated with a plurality of credit cards, gift cards a bank account and the like. Such a customer subscribing to the payment service according to embodiments of the invention, using any of the methods disclosed above, may enter several account details. For example, after providing the biometric data (e.g., give a fingerprint, take a photo and the like) the customer may enter a first credit card details, a second credit card details, a gift card details and a bank account details and server 160 may associate the biometric data with all the given payment accounts details. In some embodiments, for a customer associate with a plurality of payment accounts (e.g., plurality of credit cards, gift cards a bank account and the like) the method may include asking the customer which one of the associated payment accounts is to be used for purchasing goods in the point of sale. Server 160 may display on mobile device 20 a request to select the payment account and may include in the first encrypted message the selected payment account and the received biometric data.

Operations 345-365 of FIG. 3 are substantially the same as operations 250-270 of FIG. 2 that were discussed above.

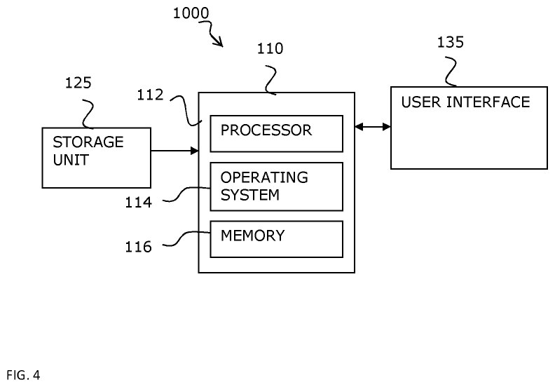

Reference is now made to FIG. 4 which is a high level block diagram of a computing system according to some embodiments of the invention. A system 1000 may be included in payment unit 105 or in other components of system 100. According to other embodiments, system 1000 may include one or more of the components of system 100. System 1000 A may include a computer processing unit 110 (e.g., that may be similar to processing unit 110 of system 100), a storage unit 125 and a user interface 135. Processing unit 110 may include a processor 112 that may be, for example, a central processing unit (CPU), a chip or any suitable computing or computational device, an operating system 114 and a memory 116. System 1000 may be included in a desktop computer, laptop commuter, a tablet, a mainframe computer or the like. Processor 112 may be configured to carry out methods according to embodiments of the present invention by for example executing instructions stored in a memory such as memory 116.

Operating system 114 may be or may include any code segment designed and/or configured to perform tasks involving coordination, scheduling, arbitration, supervising, controlling or otherwise managing operation of processing unit 110, for example, scheduling execution of programs. Operating system 114 may be a commercial operating system. Memory 116 may be or may include, for example, a Random Access Memory (RAM), a read only memory (ROM), SSD (Solid state drive), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 116 may be or may include a plurality of, possibly different memory units.

Memory 116 may store any executable code, e.g., an application, a program, a process, task or script. The executable code may include codes for controlling the display of an image stream or any other codes or instruction for executing methods according to embodiments of the present invention. The executable code may be executed by processor 112 possibly under control of operating system 114.

Storage 125 may be or may include, for example, a hard disk drive, a floppy disk drive, a Compact Disk (CD) drive, a CD-Recordable (CD-R) drive, a universal serial bus (USB) device, a SSD (Solid state drive), or other suitable removable and/or fixed storage unit. Content may be stored in storage 120 and may be loaded from storage 120 into memory 116 where it may be processed by processor 112. For example, storage 120 may include an image stream including a plurality of image frames, data related to the image frames and/or data related to abnormal findings or suspicious behavior according to embodiments of the invention.

User interface 135 may be or may include a screen (e.g., a monitor, a display, a CRT, etc.), a pointing device and an audio device. User interface 130 may include or be associated with other input devices such as, a keyboard. The pointing device may be a mouse, a touch screen or a pad or any other suitable device that allows a user to control (e.g., by hand or finger movements) a pointing indicator (e.g., a cursor) located on the screen. In some embodiments, the screen and the pointing device may be included in a single device, for example, a touch screen. User interface 135 may include audio device such as one or more speakers, earphones and/or any other suitable audio devices. It will be recognized that any suitable number of output devices may be included in user interface 135. Any applicable input/output (I/O) devices may be connected to processing unit 110. For example, a wired or wireless network interface card (NIC), a modem, printer or facsimile machine, a universal serial bus (USB) device or external hard drive may be included in user interface 135.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

The storage medium may include, but is not limited to, any type of disk including floppy disks, optical disks, compact disk read-only memories (CD-ROMs), rewritable compact disk (CD-RWs), and magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage unit.

A system according to embodiments of the invention may include components such as, but not limited to, a plurality of central processing units (CPU) or any other suitable multi-purpose or specific processors or controllers, a plurality of input units, a plurality of output units, a plurality of memory units, and a plurality of storage units. A system may additionally include other suitable hardware components and/or software components. In some embodiments, a system may include or may be, for example, a personal computer, a desktop computer, a mobile computer, a laptop computer, a notebook computer, a terminal, a workstation, a server computer, a tablet computer, a network device, or any other suitable computing device. Unless explicitly stated, the method embodiments described herein are not constrained to a particular order or sequence. Additionally, some of the described method embodiments or elements thereof can occur or be performed at the same point in time.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A system for payment in a point of sale, comprising:
a payment unit; and
one or more remote servers,
wherein the payment unit comprises:
one or more biometric sensors;
a communication unit comprising a first cannel for communicating with a cash register and a second channel for communicating with the one or more remote servers; and
a local processor configured to:
receive biometric data of a person from the one or more biometric sensors;
receive a request for payment from the cash register, via the first channel;
encrypt the received biometric data and the received request for payment to form a first encrypted massage;
send the first encrypted massage to the one or more remote servers, via the second channel;
decrypt a second encrypted massages received from the remote server, via the second channel, comprising a payment confirmation from a payment processor; and
send the payment confirmation to the cash register, via the first channel,
and wherein at lest one remote server from the one or more remote servers is configured to:
decrypt the first encrypted message;
compare the biometric data to stored identified biometric data;
determine an identity score for the biometric data based on the comparison;
send the request for payment and payment account details associated with the biometric data to the payment processor if the determined identity score is above a threshold value;
receive the payment confirmation from the payment processor;
encrypt the payment confirmation code to form the second encrypted message; and
send the second encrypted message to the payment unit.

2. The system of claim 1, wherein the biometric data comprises data received from two or more types of biometric sensors.

3. The system of claim 1, wherein the at least one remote server is further configured to:
receive an additional data related to the person; and
determine the identity score for the biometric data also based on the additional data.

4. The system according to claim 1, each of the one or more remote servers is further configured to:
verify that the first and second channels are authorized communication channels prior to receiving the first encrypted message.

5. The system according to claim 1, wherein the first channel is configured to send and receive the first and second encrypted messages via an encrypted communication protocol.

6. The system according to claim 1, further comprising:
an intercepting unit configured to:
send the payments unit the request for payment from the cash register; and
send the payment confirmation from the payment unit to the cash register.

7. The system according to claim 1,
wherein the local controller is further configured to: receive, via an input device, payment account details associated with the person,
and the first encrypted massage further includes the payment account details; and
wherein the remote server is further configured to:
associate the biometric data of the person with the payment account details.

8. The system according to claim 1, wherein the remote server is further configured to:
send to a mobile device associated with the person a message;
receive from the mobile device a response to the sent message; and
verify the identity of the person based on received response.

9. The system according to claim 1, wherein each of the one or more remote servers is further configured to:
receive a plurality of first encrypted messages, over a period of time, each of the first encrypted message comprises biometric data of the same person;
compare the received biometric data to stored identified biometric data;
determine identity scores for the received biometric data based on the comparison; and
update the threshold value based on the determined identity scores.

10. A method of payment in a point of sale, comprising:
receiving biometric data of a person from one or more biometric sensors;
receiving a request for payment from a cash register;
encrypting the received biometric data and the received request for payment to form a first encrypted massage;
sending the first encrypted massage to a remote server;
decrypting the first encrypted message, by the remote server;
comparing the biometric data to stored identified biometric data;
determining an identity score for the biometric data based on the comparison;
sending the request for payment and payment account details associated with the biometric data to a payment processor if the determined identity score is above a threshold value;
receiving a payment confirmation from the payment processor;
encrypting the payment confirmation to form a second encrypted message; and
sending the second encrypted message to a payment unit,
decrypting the second encrypted massages received from the remote server comprising the payment confirmation from the payment processor; and
sending the payment confirmation to the cash register.

11. The method of claim 10, wherein the biometric data comprises data received from two or more types of biometric sensors.

12. The method of claim 10, further comprising:
receiving an additional data related to the person; and
determining the identity score for the biometric data also based on the additional data.

13. The method according to claim 10, further comprising:
receiving, via an input device, payment account details associated with the person,
wherein the first encrypted massage further includes the payment account details; and
associating the biometric data of the person with the payment account details.

14. The method according to claim 10, further comprising:
sending to a mobile device associated with the person a message; and
receiving from the mobile device a response to the sent message;
verifying the identity of the person based on the received response.

15. The method according to claim 10, further comprising:
receiving a plurality of first encrypted messages, over a period of time, each of the first encrypted message comprises biometric data of the same person;
comparing the received biometric data to stored identified biometric data;
determining identity scores for the received biometric data based on the comparison; and
updating the threshold value based on the determined identity scores.

16. A method of associating biometric data with a person, comprising:
receiving biometric data of a person from one or more biometric sensors;
receiving payment account details associated with the person;
encrypting the received biometric data and the received payment account details to form a first encrypted massage;
sending the first encrypted massage to one or more remote servers;
decrypting the first encrypted message, by the one or more remote servers; and
associating the biometric data of the person with the payment account details.

17. The method of claim 16, further comprises:
receiving a request for payment from a cash register;
encrypting the request for payment to be included in the first encrypted massage;
determining an identity score for the biometric data;
sending the request for payment and the payment account details associated with the biometric data to a payment processor if the determined identity score is above a threshold value;
receiving a payment confirmation from the payment processor;
encrypting the payment confirmation to form the second encrypted message; and
sending the second encrypted message to a payment unit,
decrypting the second encrypted massages received from the remote server comprising the payment confirmation from the payment processor; and
sending the payment confirmation to the cash register.

18. The method of claim 16, wherein the biometric data comprises data received from two or more types of biometric sensors.

19. The method according to claim 17, further comprising:
receiving an additional data related to the person; and
determining the identity score for the biometric data also based on the additional data.
